(19) United States
(12) Patent Application Publication
(10) Pub. No.: US 2004/0121914 A1
(43) Pub. Date: Jun. 24, 2004

(54) Organic, combined herbicide and fertilizer

(76) Inventor: Frank Catalano, Middletown, CT (US)

Correspondence Address: MERCHANT & GOULD PC, P.O. BOX 2903, MINNEAPOLIS, MN, 55402-0903, US

(21) Appl. No.: 10/688,192

(22) Filed: Oct. 16, 2003

Related U.S. Application Data
(60) Provisional application No. 60/419,271, filed on Oct. 17, 2002.

(51) Int. Cl. A01N 37/44; A01N 33/00

(52) U.S. Cl. 504/322; 504/326

(57) ABSTRACT

The invention is an organic, combined herbicide and fertilizer that includes a proportion of betaine by volume percent (“vol %) ranging from between 50 and 97 vol %; a proportion of organic fertilizer ranging from between 1 to 15 vol %; a proportion of adjuvants ranging from 1 to 15 vol %; and between 1 and 48 vol % of a water carrier. The organic, combined herbicide and fertilizer eliminates or controls weeds within established plant communities, such as turfgrasses, without use of artificial post-emergent contact herbicides that are hazardous to users and the environment.

### RELATED APPLICATION

This application claims priority under 35 U.S.C. §119(e) to U.S. provisional application serial No. 60/419,271 filed on Oct. 17, 2002, incorporated by reference herein.

### FIELD OF THE INVENTION

The present invention relates to control of unwanted, plants or weeds within an established plant community such as a turfgrass lawn, and especially relates to an organic, combined herbicide and fertilizer.

### BACKGROUND OF THE INVENTION

It is well known that large plant communities such as recreational and home lawns are maintained in modern American and Western urban, suburban and rural environments through rigorous cultural practices. Included amongst such common cultural practices are regular fertilization; application of herbicides to control unwanted plants; application of insecticides to control insect pests; detailed soil analysis to measure pH and nutrient loads and exchange capacities of soils, and amendatory practices in response to such a soil analysis; application of irrigation water to feed water to the plants, to cool the plants, and to wash in some fertilizers and pesticides; and various mechanical cultural practices, such as core aerating, slice seeding, over seeding, etc.

Such practices are known to produce desirable recreational lawns for sports activities such as golf, baseball and football, as well as to produce an attractive, valuable home lawn. It has become a multi-billion dollar industry to provide materials for maintenance of attractive lawns, and, especially for home lawns, it has become an enormous industry to provide and maintain fine lawns for homeowners, by regular implementation of the described cultural practices by both homeowners, and by lawn-care vendors.

Unfortunately however, it is also well known that implementation of lawn care programs has produced lawns that are dependent upon those intensive cultural practices. Even worse, such practices are deleterious to the environment because they typically utilize synthetic, soluble, high salt-content fertilizers and toxic pesticides, including weed-control herbicides. One of the compounds added to turfgrass lawns is generally characterized as a “herbicide”, meaning that it will kill or suppress unwanted, competitive broad leaf weeds. One common form of herbicide is referred to as a “pre-emergent” herbicide that is applied to kill or suppress annual plants just after they emerge from their seeds. Typically a pre-emergent herbicide is applied to a target turfgrass community at a time the manager of the lawn knows the unwanted annual seeds are about to germinate, such as in mid to late Spring. The pre-emergent herbicide produces a layer on the surface of the soil that the young annual seedling must penetrate, and in doing so the herbicide kills most of the seedlings. The most common unwanted annual seed that is controlled by such pre-emergent herbicide treatment is crab grass.

Another common form of herbicide is a post-emergent, contact herbicide for control of broad leaf weeds. For purposes herein, it is recognized that the botanically accepted meaning of the word “weed” is a subjective standard of “an unwanted plant”. However, with respect to turfgrass lawn plant communities, and for purposes herein of developing a stable, healthy turfgrass community, the word “weed” means any plant that will disrupt the stability and health of the desired turfgrass plants. More particularly, the term “broad leaf weed” will refer to any of a variety of well known dicotyledon plants that are considered to be undesirable in an established, turfgrass lawn, such as dandelions, plantain, chick weed, clover, etc. Typical broad leaf weed control by post-emergent herbicides is achieved by application of the herbicide to the plant community so that an active, plant destructive compound within the herbicide contacts and penetrates the broad leaf weed.

It is well known that such broad leaf weed herbicides are extremely dangerous to both the environment and humans that are exposed to the herbicides. Typically, lawns that receive application of broad leaf herbicides should not be utilized for several days, and many laws have been enacted requiring herbicide applicators to post signs warning users to stay of the lawns. The herbicide cannot be “washed into” the root zone of the plants because it must stay in contact with the leaves of the broad leaf weeds. Therefore, it is common that the compounds are frequently adsorbed onto the shoes of children playing upon the lawns or golfers, etc. using a treated lawn, and then transferred into the homeowner's rugs by the same shoes to become long-term household contaminants. Additionally, such post-emergent, broad leaf weed herbicides pose enormous environmental hazards as they run off the plants by rain water, or are leached through the soil into subterranean water movement to ultimately flow into nearby streams, aquifers, ponds, lakes, rivers, and ultimately the oceans of the world. It is well known that the herbicides severely disrupt ecosystem wherever not-targeted plants take up, and are damaged by the herbicides. Additionally, it is increasingly appreciated that such ground water contamination poses health risks to humans.

Accordingly, there is a need for an organic weed herbicide that effectively controls unwanted weeds, and that is safe for applicators of the herbicide, for users of the plant community receiving the herbicide, and that is not a hazard to the environment.

### DESCRIPTION OF THE PREFERRED EMBODIMENTS

The invention is an organic, combined herbicide and fertilizer that includes three major components. The first component is an organic herbicide referred to as “betaine”, which is also known as trimethylglycine. Betaine is a nitrogenous compound found in beet molasses, and is known to be used in pharmaceutical, cosmetic food, fermentation and agricultural industries. The second major component is an organic fertilizer, consisting of at least an organic source of plant-derived nitrogen, and possibly some fulvic acid and humic acid. The third major component includes organic adjuvants to increase the herbicidal effect of the betaine, and to enhance recovery of the monocotyledon turfgrasses to which the invention has been applied. The components are mixed, and/or suspended within a water carrier.

To achieve a herbicidal effect of limiting or killing specific, unwanted plants, the organic, combined herbicide and fertilizer must be applied at a rate so that the betaine is applied at a rate of greater than 40 kilograms per hectare (“kg/ha”).

The organic, combined herbicide and fertilizer includes a proportion of betaine by volume percent (“vol %”) ranging from between 50 and 97 vol %; a proportion of organic fertilizer ranging from between 1 to 15 vol %; a proportion of adjuvants ranging from 1 to 15 vol %; and a proportion of water as a carrier ranging from 1 to 48 vol %.

The herbicide component betaine is known to exhibit herbicidal effects, and is disclosed as useful in agricultural applications in U.S. Pat. No. 5,922,649 that issued on Jul. 13, 1999 to Pehu et al., and in U.S. Pat. No. 6,083,876 that issued on Jul. 4, 2000 to Jokinen et al. It can be acquired from the Monitor Sugar company of Bay City, Mo. 48706. Additionally, the herbicide component betaine may be provided in the form of a powdered concentration of trimethylglycine, that may make up preferably between 1 to 15 vol %, or more in certain circumstances, of the herbicide component. The powdered concentration may be acquired under the name “BETAFIN BF” from the Danisco Cultor America company of Philadelphia, Pa.

The organic fertilizer component includes nitrogen that is derived from plants, such as soy bean extracts, as disclosed in U.S. Pat. No. 6,406,511 that issued on Jul. 18, 2002 to Haim B. Gunner et al. Such an organic fertilizer is available under the brand name “BIOSOF”, from the EcoOrganics company of North Amherst, Mass. 01002. The macro-nutrient (nitrogen, phosphorous, potassium) analysis of “BIOSOF” is 14-0-0. The organic fertilizer may be enhanced by the addition of fulvic acid and humic acid, so that the total weight percent (“wt %”) constituents of the organic fertilizer are fulvic acid 3-20 wt %; humic acid 10-75 wt %, balance plant extract organic nitrogen source. For purposes herein, the phrase “organic fertilizer” refers to the fertilizer component of the invention as being only the plant extract nitrogen alone, while the phrase “enhanced organic fertilizer” refers to the plant extract nitrogen source plus the aforesaid proportions of fulvic acid and humic acid. Fulvic acid and humic acid may be acquired from the Faust Bio-Agricultural Services Company of Honaunau, Hi.

The adjuvant component consisting of organic adjuvants, includes at least one of the following listing of organic adjuvants:

1. An organic adjuvant available under the brand name “RAGE”, available from the Teva Company of Troy, Ohio 45373, which services to aid in the adherence, and/or penetration of the betaine into the target plant.

2. An organic adjuvant available under the brand name “BUG JUICE”, from the K. P. White & Company of Port Richey, Fla. 34668, which serves to aid in the adherence, and/or penetration of the betaine into the target plant.

3. An organic crop oil, such as an oil available under the brand name “PF-0323 Crop Oil”, from the Pammark Farms Ltd. of Marysville, Ohio 43040, which serves to aid in the adherence, and/or penetration of the betaine into the target plant.

4. An organic wetting agent, such as available under the brand name ‘COCO-WET ALL NATURAL WETTING AGENT”, from the Home Harvest Garden Supply Company of Baltimore Md. 21224, which serves to weaken the surface tension of a carrier water to thereby assist in distribution, adherence, and/or penetration of the betaine into the target plant.

5. An organic adjuvant such as available under the brand name “RAIN GROW”, from the Rain Grow Company of Oliver, British Columbia VOH 1TO, which services to aid in the adherence and/or penetration of the betaine into the target plant.

6. An organic adjuvant such as available under the brand name “CB-707”, from the Ecochem Company of Hanna, Alberta TOJ 1PO, Canada, which serves to aid in the adherence and/or penetration of the betaine into the target plant.

7. Organic, pure yucca, available from the Agri-Growth International Company of Edmonton, Alberta T53 2J5, Canada, which serves to aid in the adherence and/or penetration of the betaine into the target plant.

8. An organic quilla saponin, available under the brand name “QL-1000”, for the Dessart King Chile Company of San Diego, Calif., which also serves to aid in the adherence and/or penetration of the betaine into the target plant.

9. Organic acetic acid, available from the AllChem Industries company of Gainesville, Fla., which serves to aid in the adherence and/or penetration of the betaine into the target plant.

10. Organic iron chelate, available from the Organic Laboratories company of Stuart, Fla. The organic iron chelate may be used in solution with the other organic, combined herbicide and fertilizer components to facilitate a rapid uptake of iron through foliage or roots of the target plants. The value of the organic iron chelate is enhanced by use of fulvic acid within the organic fertilizer component, as described above. The fulvic acid maintains the iron in a plant available form, and the fulvic acid may also free up other micronutrients for plant uptake by roots of the plants. Use of the organic iron chelate within the organic, combined herbicide and fertilizer as a foliar spray is less phytotoxic than use of synthetic iron chelates.

The total volume percentage of the organic adjuvant component of the organic, combined herbicide and fertilizer ranges between 1% and 15%. In all embodiments of the invention, at least one of the organic adjuvants is utilized, and if only one such adjuvant is utilized, it is the aforesaid fifth organic adjuvant that is available under the brand name “RAIN GROW”, that serves to aid in the adherence and/or penetration of the betaine into the target plant. In a first preferred adjuvant embodiment, the following additional adjuvants are utilized: the organic pure yucca, and the eighth organic adjuvant organic saponin.

Research by the inventor of the present organic, combined herbicide and fertilizer has demonstrated unexpected and remarkable control of not only broad leaf weeds in turfgrass communities, but also has exhibited significant control of unwanted monocotyledon “crab grass” weeds in turfgrass communities. The remarkable, and unexpected results has been achieved by a first preferred embodiment of the organic, combined herbicide and fertilizer, including about 70 vol % betaine organic herbicide; about 18 vol % “BIOSOF” organic fertilizer; about 2 vol % saponin organic adjuvant; and, about 10 vol % water.

By use of the present organic, combined herbicide and fertilizer, synthetic, non-organic, hazardous, known herbicides do not have to be used, thereby benefiting both the ecosystem of the target turfgrass community, as well as the overall environment.

While the present invention has been described with respect to particular embodiments of an organic, combined herbicide and fertilizer, it is to be understood that the invention is not to be limited to the described embodiments. Consequently, reference should be made primarily to the following claims rather than the foregoing description to determine the scope of the invention.

I claim:

1. An organic, combined herbicide and fertilizer for use on plant communities, comprising:
(a) between 50 and 97 volume percent of a betaine organic herbicide;
(b) between 1 and 15 volume percent of an organic fertilizer;
(c) between 1 and 15 volume percent of organic adjuvants; and,
(d) between 1 and 48 volume percent of a water carrier.

2. The organic, combined herbicide and fertilizer of claim 1, wherein the organic fertilizer comprises an enhanced organic fertilizer, including a plant extract organic nitrogen source, fulvic acid and humic acid, so that the total weight percent constituents of the organic fertilizer are fulvic acid 3-20 wt %, humic acid 10-75 wt %, balance plant extract organic nitrogen source.

3. The organic, combined herbicide and fertilizer of claim 1, including a first preferred adjuvant embodiment comprising an organic adjuvant that aids in the adherence and/or penetration of the betaine into the target plant.

4. The organic, combined herbicide and fertilizer of claim 1, including a second preferred adjuvant embodiment comprising an organic adjuvant aids in the adherence, and/or penetration of the betaine into the target plant and organic pure yucca.

5. A method of controlling unwanted plants in a plant community comprising the step of applying a combined organic, herbicide and fertilizer that includes between 50 and 97 volume percent of a betaine organic herbicide, between 1 and 15 volume percent of an organic fertilizer, between 1 and 15 volume percent of organic adjuvants, between 1 and 48 volume percent of a water carrier, wherein the combined organic, herbicide and fertilizer is applied to the plant community at a rate so that the betaine organic herbicide is applied at a rate of over 40 kilograms per hectare.
